(19) United States
(12) Patent Application Publication
(10) Pub. No.: US 2012/0297015 A1
(43) Pub. Date: Nov. 22, 2012

(54) SYSTEM AND METHOD FOR BUILDING DATA RELEVANT APPLICATIONS

(75) Inventors: Birame Sock, Miami Beach, FL (US); Neil Garnichaud, Port Saint Lucie, FL (US)

(73) Assignee: THIRD SOLUTIONS, INC., Miami Beach, FL (US)

(21) Appl. No.: 13/111,245

(22) Filed: May 19, 2011

(51) Int. Cl. G06F 15/16

(52) U.S. Cl. 709/217

(57) ABSTRACT

A secure environment where third party application can access confidential consumer information without having the confidential consumer information identifiable to the third party application. The method and system may include pushing information to the third parties servers. Multiple data access methods may be used including direct token based access to data stored on systems as well as access to external information using a anonymous token generation per an external request. The external response would be normalized and merge with managed data into a single set of data for third party application processing.

### BACKGROUND OF THE INVENTION

1. Field of the Invention

The field of the present invention is related to data processing. In particular, the field of the invention is directed towards software applications.

2. Description of the Related Technology

A typical software application draws on data from a user's own database or from an external, third party database using a query to the database, which results in a response from that database with information related to the query. The data retrieved is typically fully utilized within the system environment where the application resides.

Software applications today generally reside within a single user system environment which includes the database required by such software application to display appropriate information to the user. Software applications may be enhanced by integrating data that resides outside of the user system environment with data from that environment.

Currently, there is no effective way for a server to transmit data from a database back and forth between multiple, third party user system environments so that a software application can access data from the platform or user system environment created and hosted by the database owner outside of the user system environment and the integrated data can be returned to the original user system environment where the software application resides. When the data being transmitted relates to sensitive data, such as personally identifiable consumer data, there is a further need to transmit such data in a manner that does not allow the third party user systems to identify the end user data source.

### SUMMARY OF THE INVENTION

An object of the present invention may be a system for implementing data relevant applications.

Another object of the invention may be a method for building data relevant applications.

Still yet another object of the present invention may be a system for providing centralized delivery of data relevant applications.

An aspect of the present invention may be a method for implementing a data relevant application system comprising: transmitting a data request from a third party application to a data relevant application system, wherein the data request is for transaction data; authenticating the third party application; generating a request token; packaging the request token with the data request; and providing the packaged data request to the third party application.

Another aspect of the present invention may be a computer implemented system for providing centralized delivery of data relevant applications comprising: a transaction data storage server; a data request manager controlling access to the user transaction data storage server; a request token generator for generating request tokens for a certified third party application; and a third party application data request authentication manager for certifying an allowed third party application.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows a diagram of the system employed in the present invention.

FIG. 2 is a flow chart showing the method of accessing third party consumer transaction data from the platform database without accessing the consumer's identity.

### DETAILED DESCRIPTION OF THE PREFERRED EMBODIMENT(S)

Disclosed is a system and method for providing a technical platform system, which is a data relevant application system that manages and handles centralized delivery of applications based on a consumer's purchasing history and possible purchasing needs. The system and method is able to control and utilize privileged information in order to tailor applications to consumers. The platform system is able to maintain a secure environment where third parties can create applications utilizing the confidential consumer information without being able to identify the individual. The application further includes pushing information to the third parties' servers.

In using the platform system, the process includes creating multiple data access methods including direct token based access to data stored on the platform systems as well as access to external information using an anonymous token generation per external request. The external response is normalized and merged with managed data into a single set of data for third party application processing.

Developers of applications for use on the platform system have access to detailed consumer information for the creation of application functionality, but cannot access the information in a manner that identifies the consumer. The application developers generate revenue promoting coupon or other reward selection and adoption by consumers. Developers of the applications may also be able to integrate external third party data.

Third party application owners and developers have the ability to access detailed consumer information on an anonymous basis, which has been gathered and aggregated from many disparate source systems, based on unique and common characteristics in the detailed receipts data to create targeted marketing campaigns.

The developers of the application can structure it so that when reward data is processed it is captured in the same data structure and as such continues to allow the ability to collect and refine detailed consumer profiles. As more rewards are generated and redeemed the system is self-fulfilling.

Detailed consumer application data can be selected for criteria in analyzing existing customer purchase trends or creating predictive purchasing trends. These characteristics may include UPC number and/or physical location of the store where the purchase has occurred.

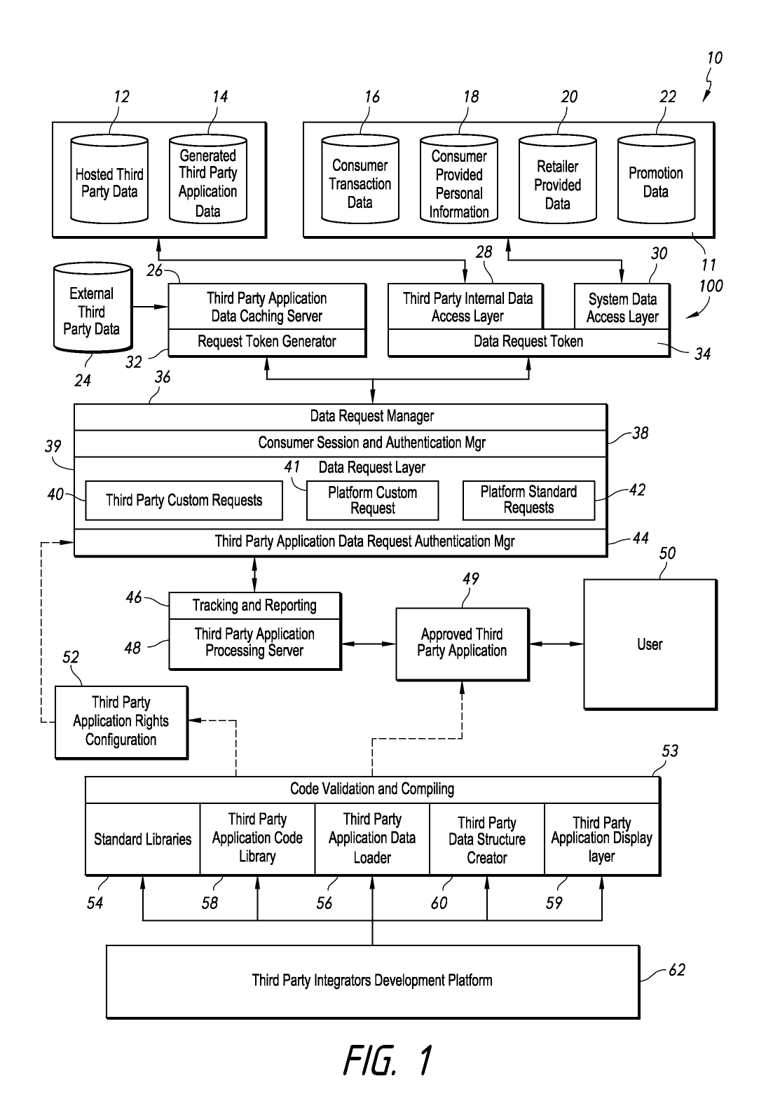

FIG. 1 shows a diagram illustrating the architecture of the platform system. The data relevant application system 100 has a hosted third party data server 12 and a generated third party application data server 14. The hosted third party data server 12 and the generated third party application data server 14 are operably connected to the third party internal data access layer 28. The third party internal data access layer 28 receives data request tokens 34 from the data request manager 36.

The data relevant application system 100 further provides a transaction data storage server 10. The transaction data storage data server 10 stores transaction data 11, which may comprise consumer transaction data 16, consumer provided personal information 18, retailer provided data 20, and promotion data 22. The promotion data may include unique details required to present rewards such as coupons, points and discounts to consumers. The transaction data 11 may also comprise purchasing history and purchasing needs of a consumer. Consumer transaction data 16 may be information related to the cost, amount and product involved in the transaction. The transaction data 11 may be obtained through a digital receipt generator or manually input by a consumer. A digital receipt generator may be a device such as the digital receipt generator disclosed in U.S. patent application Ser. No. 13/078,533 and U.S. patent application Ser. No. 12/253,994 the contents of which are incorporated herein by reference. A software application developed by a third party may be implemented in the data relevant system 100. The software application preferably would employ transaction data 11.

The transaction data storage server 10 is operably connected to the core system data access layer 30. The system data access layer 30 receives data request tokens 34 from the data request manager 36.

The data request manager 36 is further operably connected to the request token generator 32, which may be anonymous request token generator, that is connected to the third party application data caching server 26. The third party application data-caching server 26 is operably connected to an external third party data server 24.

A consumer session and authentication manager 38 is operably connected to the data request manager 36. The consumer session and authentication manager 38 is also operably connected to a data request layer 39. The data request layer 39 receives third party custom requests 40, platform custom requests 41 and platform standard requests 42. These requests are generated from the third party application data request authentication manager 44.

The third party application data request authentication manager 44 receives and transmits tracking and reporting data 46 from the third party application processing server 48. The third party application processing server 48 communicates with approved third party applications 49 and further transmits and receives information from the user 50. Third party application rights configuration 52 is operably connected to the third party application data request authentication manager 44. The third party application rights configuration 52 is also operably connected to the platform code validation and compiling layer 53.

The platform validation and compiling layer 53 is operably connected to platform standard libraries 54, third party application code library 58, third party application data loader 56, third party data structure creator 60, third party application display layer 59 and third party integrators development platform 62.

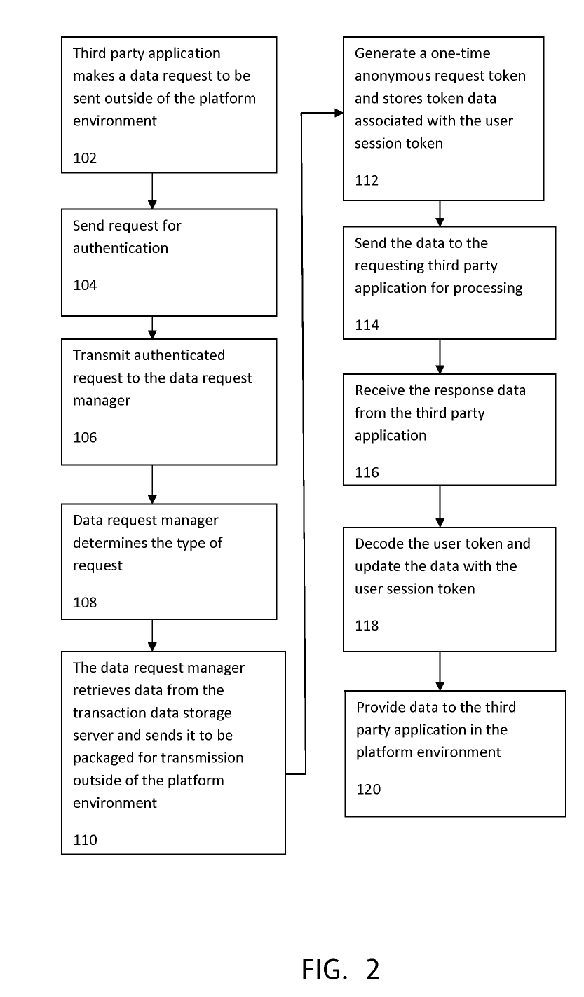

FIG. 2 is a flow chart illustrating the method of how a third party application implemented by a user 50 accesses consumer transaction data 16 from the transaction data storage server 10 without accessing the consumer's identity.

In step 102, a third party application being used by a user 50 makes a data request to be sent outside of the platform environment. In step 104, the data relevant application system 100 authenticates the third party application. In step 106, the data relevant application system 100 performs the steps necessary to transmit the authenticated request to the data request manager 36. In step 108, data request manager 36 determines the type of request being made by the third party application.

In step 110, the data request manager 36 retrieves the requested data from the transaction data storage server 10 and sends it to be packaged for transmission outside of the platform environment. By being packaged for transmission outside the platform environment it is meant that those steps necessary to mask the personal information related to the requested data are performed. For example, in step 112, if in step 108 the data request manager 36 determines that the request is made by a third party application, a one-time anonymous user token may be generated by the system, or alternatively a user token that is not anonymous may be used. Token data associated to a user's session token is stored. An anonymous user token may be set to expire after one use or after a predetermined amount of time.

In step 114, the requested data is sent to the third party application for processing. The processing by the third party application involves integrating appropriate information residing on the third party servers and returning the integrated data package to the data relevant application system 100. The integrated data package is a normalized and merged single set of data for third party application processing. In step 116, the response data, which may be the integrated data package is received from the third party application by the data relevant application system 100. In step 118, the data relevant application system 100 decodes the user token and updates the data with the user session token 118. In step 120, data is provided to the third party application in the platform environment.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method for implementing a data relevant application system comprising;
transmitting a data request from a third party application to a data relevant application system, wherein the data request is for transaction data;
authenticating the third party application;
generating a request token;
packaging the request token with the data request; and
providing the packaged data request to the third party application.

2. The method of claim 1, further comprising receiving an integrated data package from the third party application.

3. The method of claim 2, where the integrated data packaged is used in the data relevant application system.

4. The method of claim 1, wherein the consumer transaction data comprises consumer transaction data, consumer provided personal information and retailer provided data.

5. The method of claim 4, further wherein the data from the transaction data storage server further comprises promotion server data.

6. The method of claim 4, wherein a digital receipt generator generates transaction data.

7. The method of claim 1, wherein the data request manager recognizes the request as originating from a third party application and generates a request token.

8. The method of claim 7, wherein the request token is an anonymous request token that expires after one usage or a pre-determined amount of time.

9. The method of claim 1, further comprising accessing external third party information.

10. The method of claim 9, wherein the external third party information is normalized and merged into a single set of data for third party application processing.

11. The method of claim 1, wherein the third party application generates rewards.

12. A computer implemented system for providing centralized delivery of data relevant applications comprising:
a transaction data storage server;
a data request manager controlling access to the user transaction data storage server;
a request token generator for generating request tokens for a certified third party application; and
a third party application data request authentication manager for certifying an allowed third party application.

13. The system of claim 12, wherein the transaction data storage server stores consumer transaction data, consumer provided personal information, retailer provided data.

14. The system of claim 13, a digital receipt generator generates transaction data.

15. The system of claim 12, wherein the data request manager recognizes the request as originating from a third party application.

16. The system of claim 12, wherein the request token, is an anonymous request token that expires after one usage.

17. The system of claim 12, wherein external third party information is normalized and merged into a single set of data for third party application processing.

18. The system of claim 12, wherein the certified third party application generates rewards.

19. The system of claim 12, further comprising a validation and compiling layer, wherein the validation and compiling layer comprises a platform manager standard library, an application code library, an application data loader, a data structure creator, and an application display layer.

20. A software application implemented in the system of claim 1.
